(19) United States
(12) Patent Application Publication
(10) Pub. No.: US 2013/0082450 A1
(43) Pub. Date: Apr. 4, 2013

(54) Collimator Exchanging Cart for Exchanging Collimators in a Detector

(71) Applicant: GENERAL MEDICAL SYSTEMS GLOBAL TECH, Waukesha, WA (US)

(72) Inventor: Changhong LIU, Beijing (CN)

(73) Assignee: GENERAL MEDICAL SYSTEMS GLOBAL TECHNOLOGY COMPANY, Waukesha, WA (US)

(21) Appl. No.: 13/630,203

(22) Filed: Sep. 28, 2012

(30) Foreign Application Priority Data
Sep. 30, 2011 (CN) 201110312406.X

(51) Int. Cl. B62B 3/02; B62B 5/06; B62B 5/04; B62B 3/04; B62B 3/10

(52) U.S. Cl. 280/35; 280/79.11; 280/47.35

(57) ABSTRACT

A collimator exchanging cart for exchanging a collimator in a detector is provided. The cart, being loaded with two collimators at one time, comprises a frame including a rotation mechanism, wherein the rotation mechanism is configured to enable the cart to be rotated at least 180 degrees. The cart further comprises two collimator receivers, two collimator fixing and releasing mechanisms, two cart positioning mechanisms, and two cart releasing mechanisms, wherein each of the two cart releasing mechanisms is used for releasing the cart individually, and is associated with a corresponding cart positioning mechanism. Each of the two collimator receivers, the two collimator fixing and releasing mechanisms, the two cart positioning mechanisms, and the two cart releasing mechanisms are symmetric about a plane of symmetry, wherein the plane of symmetry is perpendicular to the ground and situated at the middle of the frame between two sides of the frame.

### BACKGROUND OF THE INVENTION

Embodiments of the present invention relate to a collimator exchanging cart for exchanging collimators in a detector.

A medical nuclear scanner system generally includes a detector. There are collimators mounted on the detector for diagnostic purposes. The nuclear scanner system generally needs different collimators to realize different diagnostic purposes, so that it is frequently necessary to exchange collimators in the detector as required. During the exchanging process, a collimator exchanging cart loaded with one collimator is transferred to the vicinity of the detector, wherein the position of the collimator in the cart is determined accurately. When exchanging the collimator, the collimator exchanging cart is accurately positioned relative to the detector so as to exchange the collimator accurately.

Only one collimator can be loaded within the prior art collimator exchanging cart at one time. During the exchanging process, the cart is moved into a floor template pocket which is used to position the cart in place, in which pocket the cart is fixed using a cart positioning mechanism. After positioning the collimator exchanging cart in place, the collimator in the detector is pulled out of the detector, and the new collimator on the collimator exchanging cart is pushed into a respective position in the detector, so as to complete the exchange of the collimator. If a plurality of collimators are to be exchanged, a plurality of collimator exchanging carts are necessary to exchange corresponding collimators, which in fact induces a waste in terms of costs, field operation spaces and labor power.

Thus, it is desired to develop an improved collimator exchanging cart capable of exchanging two collimators on the same detector at one time. Such a collimator exchanging cart would be more efficient, and should not impact the exchanging accuracy of the collimators.

### BRIEF DESCRIPTION OF THE INVENTION

According to an embodiment of the present invention a collimator exchanging cart for exchanging collimators in a detector is provided. The collimator exchanging cart, being loading with two collimators at one time, comprises a frame including a rotation mechanism, wherein the rotation mechanism configured to enable the cart to be rotated at least 180 degrees. The collimator exchanging cart further comprises two collimator receivers for receiving the two collimators, two collimator fixing and releasing mechanisms for fixing and releasing the two collimators, two cart positioning mechanisms for accurately positioning the cart relative to the detector, and two cart releasing mechanisms, wherein each of the two cart releasing mechanisms is used for releasing the cart individually, and is associated with a corresponding cart positioning mechanism. Each of the two collimator receivers, the two collimator fixing and releasing mechanisms, the two cart positioning mechanisms, and the two cart releasing mechanisms are symmetric about a plane of symmetry, wherein the plane of symmetry is perpendicular to the ground and situated at the middle of the frame between two sides of the frame, each side being matched with the detector when the two collimators are exchanged.

### BRIEF DESCRIPTION OF THE FIGURES

The foregoing and other features and advantages of the invention will be better understood and appreciated after carefully studying the following detailed description of the exemplary embodiments taken in conjunction with the accompanying drawings; wherein:

FIG. 1 is a front view of a collimator exchanging cart in accordance with an embodiment of the invention, which can be loaded with two collimators at one time;

FIG. 2 is a perspective view of the collimator exchanging cart illustrated in FIG. 1;

FIG. 3 is a front view of a collimator exchanging cart in accordance with an embodiment of the invention, which can be loaded with two collimators at one time;

FIG. 4 is a perspective view of the collimator exchanging cart illustrated in FIGS. 3; and

FIG. 5 is a side view of the collimator exchanging cart illustrated in FIG. 3.

### DETAILED DESCRIPTION OF THE INVENTION

In a conventional process of exchanging a collimator in a detector mounted on a nuclear scanner system, a conventional collimator exchanging cart is used. The conventional collimator exchanging cart comprises a collimator receiver for receiving a collimator;, a collimator fixing and releasing mechanism for fixing and releasing the collimator, a cart positioning mechanism for accurately positioning the cart relative to the detector, and a cart releasing mechanism for releasing the cart and associated with the cart positioning mechanism. These mechanisms can be realized utilizing any suitable construction as known to those skilled in the art. These features will not be described in detail in this specification for the purpose of simplicity.

When exchanging the collimator in the detector with a new collimator loaded within the collimator exchanging cart, the collimator exchanging cart is moved into a floor template pocket for positioning the cart in place, in which the cart is fixed by the cart positioning mechanism. After the collimator exchanging cart is positioned in place, the collimator to be exchanged is pulled out of the detector, and the new collimator on the collimator exchanging cart is pushed into a corresponding position in the detector, so as to complete the exchange of the collimator. In order to realize a rapid and efficient exchange of the collimator, the portion of the collimator exchanging cart for loading the collimator must be positioned accurately relative to the detector. In order to realize an efficient exchange, the collimator is generally situated at one side, proximate to the detector, when the collimator exchanging cart is positioned in place. This reduces the moving distance during the exchange, and thus, the side of the collimator exchanging cart proximate to the detector must be positioned accurately. In order to realize this effect, the positioning mechanism is generally situated at the side which is proximate to the detector when the cart is in place.

However, as described above, there is only one collimator loaded within the prior art collimator exchanging cart. In order to improve efficiency and reduce costs, this invention provides a collimator exchanging cart loaded with two collimators at one time.

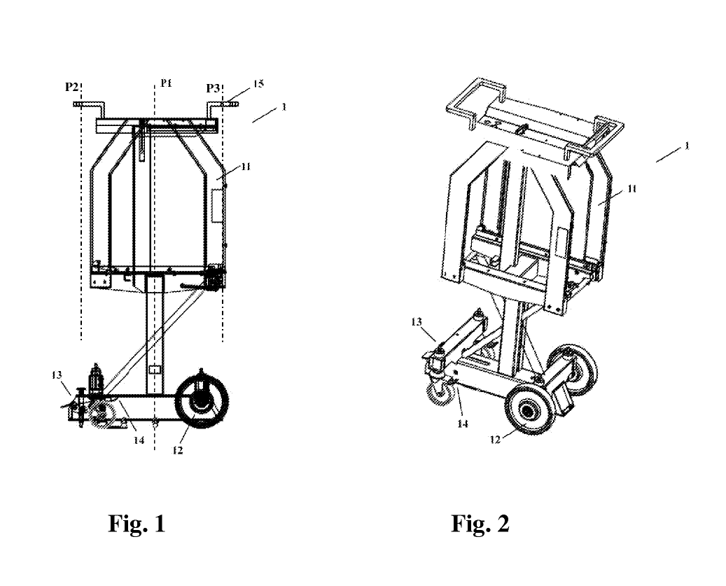

FIG. 1 is a front view of an embodiment of a collimator exchanging cart 1 in accordance with an embodiment of the present invention, which can be loaded with two collimators at one time. FIG. 2 is a perspective view of the collimator exchanging cart 1 illustrated in FIG. 1. For the convenience of describing the construction of the cart 1, terms “first exchange side” and “second exchange side” are employed. The first exchange side refers to the side proximate to, or matched with, the detector upon exchanging one of the collimators. This first side corresponds to the left side P2 of the cart 1 as illustrated in the front view of FIG. 1. The second exchange side refers to the side proximate to, or matched with, the detector upon exchanging the other of the two collimators. This second side corresponds to the right side P3 of the cart 1 as illustrated in the front view of FIG. 1.

The collimator exchanging cart 1 comprises a frame 11 having a rotation mechanism 12, the rotation mechanism 12 configured to enable the cart 1 to be rotated at least 180 degrees. In an embodiment, the rotation mechanism 12 enables the cart 1 to be rotated freely by any angle on the ground. The rotation mechanism 12 may comprise a plurality of wheels mounted on each corner of the frame 11 of the cart 1, respectively.

Moreover, as described above, the cart 1 comprises a collimator receiver (not shown), a collimator fixing and releasing mechanism (not shown), a cart positioning mechanism 13 and a cart releasing mechanism 14. However, different from the prior art cart, the collimator exchanging cart 1 in this invention has a pair of (two) collimator receivers, two collimator fixing and releasing mechanisms associated with the two collimator receivers, two cart positioning mechanisms 13 and two cart releasing mechanisms 14, and each pair of corresponding components are symmetric about the same plane Pl.

As illustrated in FIG. 1, P1 may be a plane which passes through the central axis of the cart 1 and is parallel to the first exchange side and the second exchange side of the cart 1. That is, the plane P1 may be situated at the position in the middle of the frame relative to the first exchange side and the second exchange side of the cart 1 (i.e., halfway between P2 and P3). With the construction described above, after the old collimator in the detector is exchanged with the collimator mounted in a collimator receiver, a next collimator can be exchanged with the collimator in the symmetrically-mirrored receiver.

It should be noted that each Figure only shows the respective structures on one side (mainly including the cart positioning mechanism 13, the cart releasing mechanism 14, etc.) and omits the symmetric structures thereof on the other side.

The cart 1 may have two handles 15 on its top, which are also symmetric about the symmetry plane P1, so as to operate the collimator exchanging cart 1 when exchanging collimators at two positions, respectively, and avoid the occurrence of a lateral interference with the detector.

In an embodiment, the cart positioning mechanism 13 comprises a positioning pin. The positioning pin cooperates with a respective hole in the floor template pocket to position the cart in place. The cart may be provided with a releasing mechanism, e.g. a pedal, for releasing the lock of the positioning pin.

In order to position the cart 1 more accurately relative to the detector, the positioning mechanism 13 may be situated at one side proximate to the detector when the cart is fixed in place through the cart positioning mechanism 13 for exchanging a collimator. To facilitate this operation, the associated releasing mechanism 14 may be situated at the same side as the positioning mechanism 13 (e.g. the first exchange side or the second exchange side in FIG. 1), or at the side opposite to the positioning mechanism 13 with respect to the detector.

Optionally, from the perspective of ergonomics, the handles 15 on the top of the cart 1 may be disadvantageous to the operator. Because the thrust acted on the top of the cart 1 may cause the cart 1 to easily fall off, the handles 15 are also disadvantageous in terms of safety.

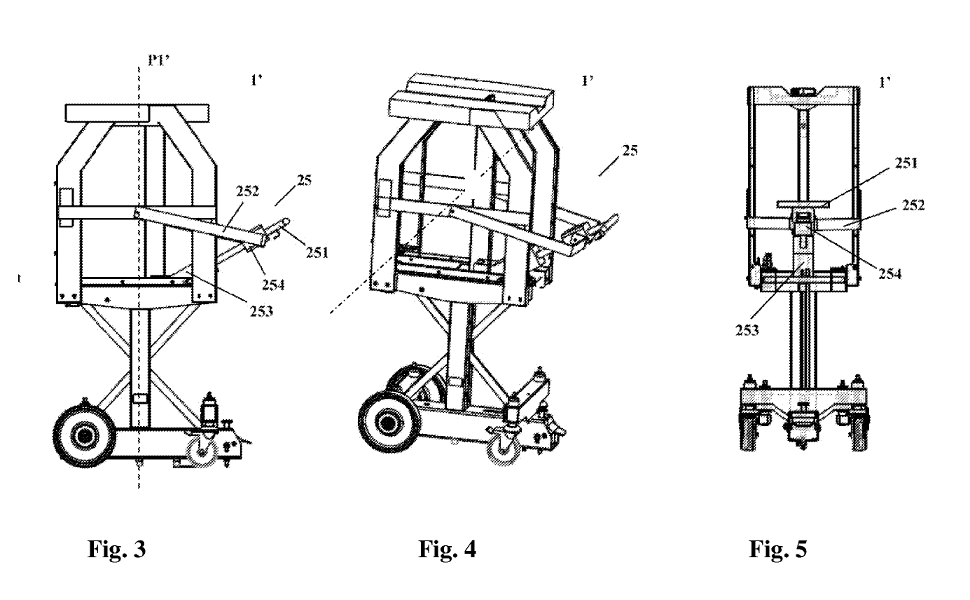

FIG. 3 is a front view of a collimator exchanging cart (designated as collimator exchanging cart 1′) in accordance with another embodiment of the invention, which can be loaded with two collimators at one time. FIG. 4 is a perspective view of the collimator exchanging cart 1′ illustrated in FIG. 3. FIG. 5 is a side view of the collimator exchanging cart 1′ illustrated in FIG. 3.

Also, for clarity, only respective structures on one side are shown, and the symmetric structures are omitted. As illustrated in FIG. 3, the cart 1′ comprises a symmetry plane P1′ corresponding to the symmetry plane P1 illustrated in FIGS. 1-2. The symmetry plane P1′ may be situated at a position just in the middle of the frame relative to the first exchange side and the second exchange side of the cart 1′. In the cart 1′ illustrated in FIGS. 3-5, there exists two collimator receivers symmetric about the symmetry plane P1′, two collimator fixing and releasing mechanisms symmetric about the symmetry plane P1′, two cart positioning mechanisms 13 symmetric about the symmetry plane P1′ and two cart releasing mechanisms 14 symmetric about the symmetry plane P1′.

The collimator exchanging cart 1′ comprises a handle assembly 25 positioned on one side thereof, instead of the handles 15 on its top. As illustrated in FIGS. 3-5, the handle assembly 25 comprises one handle 251, one handle connecting bracket 252, two handle fixing blocks 253 and one handle connecting block 254. The handle connecting bracket 252 is mounted to the frame at a height adapted to be grasped by a hand, and can be rotated at least 180 degrees about an axis A1, which is in the symmetry plane P1′ and parallel to the ground. The handle assembly 25 may be situated proximate to the middle (i.e. the middle height) of the cart 1′ in the vertical direction. The handle connecting block 254 is pivotably mounted on the handle connecting bracket 252, and has an opening for the handle 251 to pass through. The two handle fixing blocks 253 are fixed on either sides of the frame respectively, symmetric about the symmetry plane P1′, and have openings for receiving and fixing the handle 251. When using the handle assembly 25 to operate the cart 1′, the handle 251 is inserted into the opening of the handle connecting block 254, and is further inserted downwardly into the opening of the handle fixing block 253. At this point, the handle 251 is fixed in the handle fixing block 253 by a handle fixture such as a pin, so as to realize the installation of the handle 251.

After the exchange of one collimator is completed, the cart 1′ will be rotated about 180 degrees on the ground, to expose the other side of this cart 1′ for exchanging the other collimator. At this time, the cart 1′ must be operated from the other side. Therefore, the handle fixture (not shown) is released firstly, and the handle 251 is then pulled out of the openings of the handle fixing block 253 and the handle connecting block 254, and then the handle connecting bracket 252 and the handle connecting block 254 mounted thereon are rotated about the axis A1 across the top of the frame. The positions of the handle connecting bracket 252 and the handle connecting block 254 are adjusted, and the handle is inserted into the opening of the handle connecting block 254 and inserted further downwardly into the opening of the other handle fixing block 253. This fixes the handle on the other side, and allows operation the cart 1′ to carry out the exchange operation of the other collimator.

In accordance with an embodiment, the handle fixture is a lock pin.

In an embodiment, the lock pin can be provided with a spring element thereon to provide an elastic lock.

Moreover, the height of the frame 11 of the cart 1, 1′ can be optionally adjusted, so as to adjust the height positions of the new collimators (used for exchanging), to realize required alignment.

By using the single cart described in this invention to exchange two collimators in one detector of a nuclear scanner system, the time and costs required to exchange collimators are reduced, while their usage by consumers is also more convenient. Moreover, the rotatable handle assembly mounted on one side of the frame in an embodiment of the present invention renders the operation of the cart more convenient, while avoiding a risk of the falling off of the cart.

In an embodiment of the exchanging cart there are two handles symmetric about the symmetry plane P1 on the top of the cart.

In an embodiment of the exchanging cart, the cart positioning mechanisms may comprise a positioning pin.

In an embodiment of the exchanging cart, the cart releasing mechanisms may comprise a pedal.

In an embodiment of the exchanging cart, the cart may comprise a handle assembly which is situated proximate to the middle of the cart in the vertical direction.

In an embodiment of the exchanging cart, the handle assembly comprises one handle, one handle connecting bracket, and one handle connecting block having an opening and two handle fixing blocks. The handle connecting bracket can be pivoted at least 180 degrees about an axis A1 in the symmetry plane P1 and parallel to the ground, and the handle connecting block is pivotably mounted to the handle connecting bracket and has an opening through which the handle passes. The two handle fixing blocks being fixed to either side of the frame, respectively, symmetric about the symmetry plane P1, and having an opening for receiving and fixing the handle, respectively.

The handle has a first position and a second position. In the first position, the handle is inserted into the opening in one of the handle fixing blocks through the opening in the handle connecting block so as to mount the handle in place. In the second position, the handle connecting bracket and handle connecting block are pivoted about the axis A1 across the top of the frame by an angle less than 180 degrees, and the handle is then inserted into the opening in the other one of the handle fixing blocks through the opening in the handle connecting block, so as to mount the handle in place.

In an embodiment of the exchanging cart, the handle assembly comprises a handle fixture for fixing the handle into the handle fixing blocks.

In an embodiment of the exchanging cart, the handle fixture comprises a combination of a latch pin and a spring.

In an embodiment of the exchanging cart, when the cart is positioned in place by a cart positioning mechanism and ready to exchange a collimator, the cart positioning mechanism and associated cart releasing mechanism are situated at the same side of the cart, or the associated cart releasing mechanism is situated at the side opposite to the cart positioning mechanism.

In an embodiment of the exchanging cart, the height of the cart frame can be adjusted, so as to adjust the height position of the collimators loaded on the cart.

As understood by those of ordinary skill in the art, many different features and constructions described above with respect to several exemplary embodiments can be selectively applied to yield other practical embodiments of the present invention. For simplicity, and taking the capabilities of those of ordinary skill in the art into consideration, not all possible iterations are provided or described in detail, but all combinations and practical embodiments comprised in several appended claims or otherwise are intended to be a part of this application. Additionally, improvements, alterations and modifications will occur to those skilled in the art in accordance with the above description of several exemplary embodiments of this invention. Such improvements, alterations and modifications in the art are also intended to be covered by appended claims. Additionally, it should be apparent that, the foregoing only relates to the described embodiments of this application, and many alterations and modifications can be made in the specification without departing from the spirit and scope of this application defined by the appended claims and their equivalents.

What is claimed is:

1. A collimator exchanging cart for exchanging a collimator in a detector, the cart being loaded with two collimators at one time and comprising:
a frame including a rotation mechanism, wherein the rotation mechanism is configured to enable the cart to be rotated at least 180 degrees;
two collimator receivers for receiving the two collimators;
two collimator fixing and releasing mechanisms for fixing and releasing the two collimators;
two cart positioning mechanisms for accurately positioning the cart relative to the detector; and
two cart releasing mechanisms, wherein each of the two cart releasing mechanisms is used for releasing the cart individually, and is associated with a corresponding cart positioning mechanism,
wherein each of the two collimator receivers, the two collimator fixing and releasing mechanisms, the two cart positioning mechanisms, and the two cart releasing mechanisms are symmetric about a plane of symmetry, wherein the plane of symmetry is perpendicular to the ground and situated at the middle of the frame between two sides of the frame, each side being matched with the detector when the two collimators are exchanged.

2. The collimator exchanging cart as claimed in claim 1, further comprising two handles on the top of the cart, wherein the two handles are symmetric about the plane of symmetry.

3. The collimator exchanging cart as claimed in claim 1, wherein the cart positioning mechanism comprises a positioning pin.

4. The collimator exchanging cart as claimed in claim 1, wherein the cart releasing mechanism comprises a pedal.

5. The collimator exchanging cart as claimed in claim 1, further comprising a handle assembly situated proximate to the middle of the cart in the vertical direction.

6. The collimator exchanging cart as claimed in claim 5, wherein the handle assembly comprises:
a handle;
a handle connecting bracket pivotable at least 180 degrees about an axis in the plane of symmetry and parallel to the ground;
a handle connecting block pivotably mounted to the handle connecting bracket and having an opening through which the handle passes; and
two handle fixing blocks fixed to either side of the frame, respectively, the two handle fixing blocks being symmetric about the plane of symmetry, and having an opening for receiving and fixing the handle,
wherein the handle has a first position and a second position, and wherein in the first position, the handle is inserted into the opening in one of the two handle fixing blocks through the opening in the handle connecting block so as to mount the handle in place, and in the second position, the handle connecting bracket and handle connecting block are pivoted about the axis across the top of the frame by an angle less than 180 degrees, and the handle is inserted into the opening in the other of the two handle fixing blocks through the opening in the handle connecting block, so as to mount the handle in place.

7. The collimator exchanging cart as claimed in claim 6, wherein the handle assembly comprises a handle fixture for fixing the handle in the handle fixing blocks.

8. The collimator exchanging cart as claimed in claim 7, wherein the handle fixture comprises a combination of a latch pin and a spring.

9. The collimator exchanging cart as claimed in claim 7, wherein, when the cart is positioned in place by a cart positioning mechanism, wherein the cart positioning mechanism and associated cart releasing mechanism are situated at the same side of the cart, or wherein the associated cart releasing mechanism is situated at the side opposite to the cart positioning mechanism.

10. The collimator exchanging cart as claimed in claim 1, wherein the height of the cart frame can be adjusted, so as to adjust the height positions of the collimators loaded in the cart.
